(19) United States
(12) Patent Application Publication
(10) Pub. No.: US 2010/0140410 A1
(43) Pub. Date: Jun. 10, 2010

(54) AIRCRAFT ICING INDICATOR

(75) Inventor: Patrick Lieven, Fronton (FR)

Correspondence Address: Perman & Green, LLP, 99 Hawley Lane, Stratford, CT, 06614, US

(73) Assignee: AIRBUS OPERATIONS (SOCIETE PAR ACTIONS SIMPLIFIEE), Toulouse (FR)

(21) Appl. No.: 12/632,959

(22) Filed: Dec. 8, 2009

(30) Foreign Application Priority Data
Dec. 9, 2008 (FR) 08 58402

(51) Int. Cl. B64D 15/20

(52) U.S. Cl. 244/134 F

(57) ABSTRACT

The icing indicator for an aircraft, of the type that can be directly and visually read by a pilot, includes means of installation at the surface of the fuselage and projecting therefrom, in combination with an already-existing device positioned above a through-hole in the fuselage, the device being modified to allow a power cable that powers the icing indicator to pass through the fuselage within its fastening. The icing indicator is preferably combined with a rain repellent spray device or on the spindle about which the windscreen wiper rotates.

### BACKGROUND

1. Field

The aspects of the disclosed embodiments generally relate into the field of aircraft equipment, and more specifically to an icing indicator.

2. Brief Description of Related Developments

The formation of ice on the exterior surfaces of aeroplanes presents a major danger, particularly during take-off and landing, because icing may rapidly increase the weight of the structure thus reducing the flight speed of the aeroplane in an ascent, which, when combined with a worsening of aerodynamic performance, leads to an increase in the stalling speed. The combination of these two phenomena has been the root cause of many an accident.

Various icing indicator devices have therefore been designed and marketed over time. Most of these are electronic, for example resistive, sensors positioned near the nose of the craft or the leading edges of the wings, which are the locations most likely to experience the first traces of icing. Indeed it is very important for the pilot to be alerted rapidly to the danger of icing and to react immediately.

### SUMMARY

The aspects of the disclosed embodiments to make it easier for the pilot to become aware of the onset of icing.

The aspects of the disclosed embodiments generally to provide a simple and inexpensive way of making the pilot aware of the onset of icing.

In one embodiment, a device according to the disclosed embodiments can be installed without any substantial modification to the aircraft, and without detracting from its mechanical integrity.

To these ends, the disclosed embodiments are aimed first of all at an icing indicator for an aircraft, of the type that can be directly and visually read by a pilot, comprising means of installation at the surface of the fuselage and projecting therefrom, in combination with an already-existing device positioned above a through-hole in the said fuselage, the said device being modified to allow a power cable that powers the icing indicator to pass through the fuselage within its fastening.

A second aspect of the disclosed embodiments is aimed at a device comprising a means of spraying a liquid product of the rain repellent type for the windscreen of an aircraft, of the type fixed to an aeroplane fuselage at the rain flap of the said aircraft, substantially facing the windscreen along a longitudinal axis of the aircraft, also comprising a visually readable icing indicator.

In one advantageous embodiment, the visually readable icing indicator is positioned on an upper part of the device, in the continuation of an axis A of attachment of the said device through a hole that passes through the fuselage of an aircraft.

Yet another aspect of the disclosed embodiments is aimed at a device comprising a windscreen wiper for a windscreen of an aircraft, of the type attached to an aeroplane fuselage at the rain flap of the said aircraft, substantially facing the windscreen along a longitudinal axis of the aircraft, also comprising a visually readable icing indicator.

In one advantageous embodiment, the visually readable icing indicator is positioned on the windscreen wiper suspension arm in the continuation of an axis A of attachment of the said windscreen wiper through a hole that passes through the fuselage of an aircraft.

This axis of attachment is also, in this instance, the spindle of the windscreen wiper motor.

It will be appreciated that combining these two items of equipment into a single device makes it possible to limit the number of holes passing through the fuselage, something which is advantageous from a structural standpoint and makes installation simpler. These arrangements therefore make it possible, without modifying the structure of the fuselage or the procedures used to manufacture it, to install in the view of the pilot, another icing indicator, of the type that is directly visually readable, thus constituting a useful form of redundancy.

It is also clear that it is therefore possible to replace an existing device that sprays rain repellent, or an existing windscreen wiper, with a combined device, during a very simple maintenance operation.

According to a preferred embodiment, the icing indicator is of passive type, comprising an elongate cylindrical component a few centimetres long, intended to project from the fuselage, the said elongate cylindrical component comprising a surface-treated part situated at the end of the icing indicator furthest from the surface of the fuselage, the said treated part comprising means encouraging the early local formation of ice when flying under conditions that give rise to icing.

This arrangement makes it possible not to interfere with the normal operation of the rain repellent spray device or of the windscreen wiper, and not to require the feeding-through of power cables. Choosing an icing indicator in the form of an elongate cylindrical component also minimizes its aerodynamic drag.

### BRIEF DESCRIPTION OF THE DRAWINGS

The aspects and advantages of the disclosed embodiments will be better understood from reading the description and from the drawings of one particular embodiment which is given purely by way of nonlimiting example, and in respect of which the drawings depict:

FIG. 1 illustrates, in a part-section side view, the placement of a visually readable icing indicator combined with a rain repellent spray device in the forward part of an aeroplane,

FIG. 2 is a more detailed view of FIG. 1,

FIG. 3 is a side view of a windscreen wiper and of a visually readable icing indicator combined, in an alternative form of embodiment of the disclosed embodiments, and

FIG. 4 is a head-on view of the aeroplane windscreen for this same alternative form of embodiment.

### DETAILED DESCRIPTION OF THE DISCLOSED EMBODIMENTS

In one embodiment, the device 1 is located in the forward part of an aeroplane fuselage.

For the remainder of the description, a longitudinal axis X is defined as being directed in the direction of travel of the aeroplane in horizontal flight, a transverse axis Y is defined as being situated in the horizontal plane and perpendicular to the longitudinal axis X, and a vertical axis Z is also defined. The terms “anterior, posterior, front/forward, rear, on top of, beneath, left, right, etc. will be used with reference to these axes. The aeroplane considered here is of the type that has symmetry with respect to a vertical plane XZ.

In one embodiment given here by way of nonlimiting example, the device 1 according to the disclosed embodiments is positioned practically at the base of the windscreen 2 of an aeroplane. It is incorporated into the fuselage 3 at the rain flap, a part of the fuselage which connects the nose of the aeroplane to the windscreen 2.

The device 1 combines a rain repellent spray device 4 and a visually readable icing indicator 5.

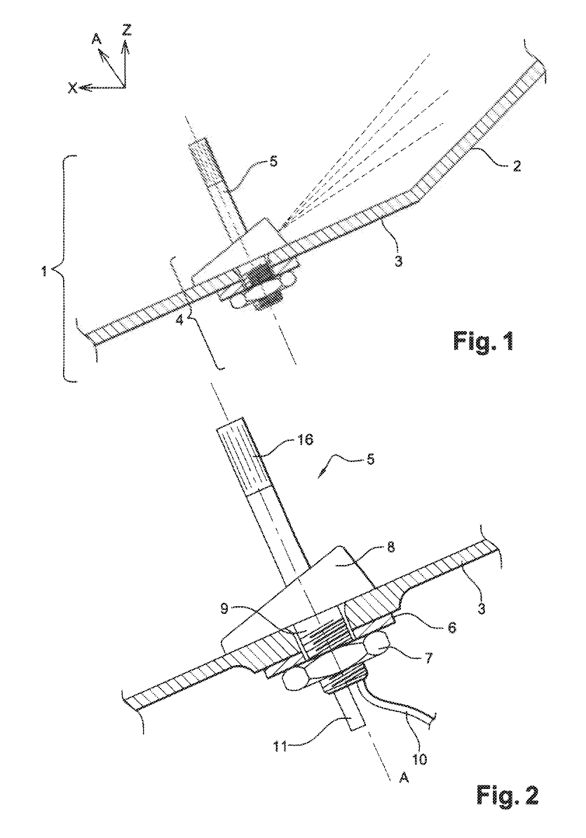

The device 1 first of all comprises an upper part 8 which is profiled in such a way as to have low aerodynamic drag and is provided with a spray orifice, not depicted in FIGS. 1 and 2, directed towards the windscreen 2.

Secondly, it comprises a lower part comprising a threaded spindle 9, directed in a direction A normal to the local surface of the fuselage, the said threaded spindle 9 being intended for fastening the device 1 to the fuselage 3 of the aeroplane through a through-hole 6 by tightening a threaded fastener 7. An electrical power cable 10, and a tube 11 supplying fluid that is to be sprayed, are connected to the device.

The rain repellent spray device 4 is, as such, of a type and operation known per se. Apart from the icing indicator 5 part, its dimensions, materials, supply and other features are not therefore detailed any further here.

The icing indicator 5 is positioned in the continuation, along the normal local axis A, of the upper part 8 of the device 1.

It is in the form of an elongate cylindrical component of chiefly circular cross section, a few centimetres long and therefore projecting from the fuselage 3 at the base of the windscreen 2 and therefore in the sight of the pilot or pilots. It comprises a grooved part 16, situated at that end of the icing indicator that is furthest from the surface of the fuselage 3 and therefore situated in an air flow that is colder than the flow flowing immediately in contact with the fuselage. In icy weather conditions, ice forms slightly more quickly on its grooved part 16 than on the remainder of the surface 3 of the fuselage.

The icing indicator 5 advantageously forms a one-piece assembly with the rain repellent spray device 4, so as to simplify installation and reduce the aerodynamic drag of the whole.

This visually readable icing indicator 5 is in itself of a known type with known features.

It is preferably of the passive type.

If the indicator is not of the passive type (for example light indicator), then it is powered by cables (not depicted) passing through the threaded spindle 9 of the rain repellent spray device 4, these cables possibly being common with those 10 of the said spray 4.

As an alternative, the icing indicator 5 is installed on the rain repellent spray device 4 by modifying the latter. In this alternative form, a drilling is made in the upper part 8 of the spray device 4, in the direction A corresponding to the threaded spindle 9, so as to optimize the reaction of aerodynamic forces created by the icing indicator 5. This drilling is of a diameter large enough to allow the passage of a spindle for fastening the icing indicator 5, which has not been depicted here.

The icing indicator is then fastened in position by bolting, welding or some other method of attachment compatible with the materials of the spray device 4 and of the icing indicator 5.

The scope of the disclosed embodiments is not restricted to the details of the embodiments considered hereinabove by way of example but on the contrary encompasses any modifications within the competence of those skilled in the art.

In an alternative form of embodiment, the device 1 according to the disclosed embodiments consists of a visually readable icing indicator 5 positioned projecting from the spindle about which a windscreen wiper 12 rotates.

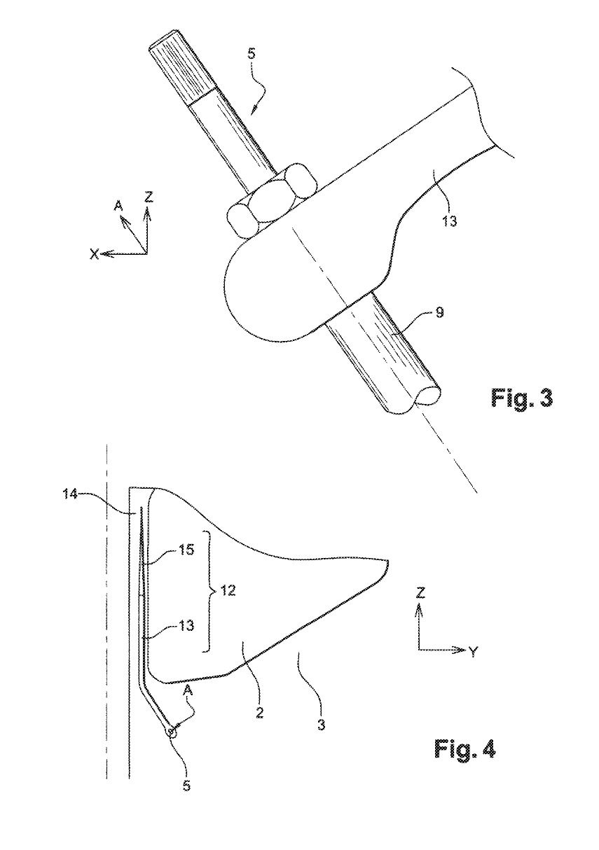

In this embodiment, which has been illustrated in FIGS. 3 and 4, the device according to the disclosed embodiments 1 is positioned on the fuselage 3 in the same way as an aircraft front windscreen wiper of known type, with the windscreen wiper 12 for example having a rest position along a vertical upright 14 separating the two front windows of the windscreen 2.

This windscreen wiper 12 is able to rotate about an axis A normal to the mean plane of the window 2a that it is to wipe.

The device 1 first of all comprises an upper part 8 comprising a suspension arm 13 and a windscreen wiper blade 15.

Secondly, it comprises a lower part comprising a spindle 9 directed in a direction A normal to the local surface of the fuselage, the said spindle 9 being used so that a drive motor, not depicted, and positioned under the surface of the fuselage 3, can rotate the windscreen wiper 12.

The spindle 9 passes through a through-hole 6.

The windscreen wiper 12 is, as such, of known type and known operation. Apart from the icing indicator 5 part, its dimensions, materials, supply and other features are therefore not detailed further here.

The icing indicator 5, of a form identical to the above description, is positioned in the continuation of the axis A of rotation of the windscreen wiper 12, above the suspension arm 9. The arrangement of the visually readable icing indicator 5 once again is suited to ease of sight by the pilots.

Advantageously, the icing indicator 5 is formed as one piece with the suspension arm 13.

It may equally be attached to a suspension arm modified a posteriori, by any suitable means, for example by bonding or bolting.

As an alternative, it is possible to use any surface treatment of the elongate cylindrical part of the icing indicator that locally encourages the early formation of ice when flying under conditions likely to cause icing.

What is claimed is:

1. An icing indicator for an aircraft, of the type that can be directly and visually read by a pilot,
wherein the icing indicator comprises means of installation at the surface of a fuselage and projecting therefrom, in combination with an already-existing device positioned above a through-hole in the fuselage,
the device being modified to allow a power cable that powers the icing indicator to pass through the fuselage within its fastening.

2. A device comprising a means of spraying a liquid product of a rain repellent type for a windscreen of an aircraft, of a type fixed to an aeroplane fuselage at a rain flap of the aircraft, substantially facing the windscreen along a longitudinal axis of the aeroplane,
wherein the device further comprises a visually readable icing indicator icing indicator for an aircraft, of the type that can be directly and visually read by a pilot, the indicator comprising means of installation at the surface of a fuselage and projecting therefrom, in combination with an already-existing device positioned above a through-hole in the fuselage,
the device being modified to allow a power cable that powers the icing indicator to pass through the fuselage within its fastening.

3. The device according to claim 2, wherein the visually readable icing indicator is positioned on an upper part of the device, in the continuation of an axis A of attachment of the device through a hole that passes through the fuselage of an aircraft.

4. A device comprising a windscreen wiper for a windscreen of an aircraft, of the type attached to an aeroplane fuselage at the rain flap of the aircraft, substantially facing the windscreen along a longitudinal axis X of the aircraft, further comprising a visually readable icing indicator, wherein the visually readable icing indicator comprises:
means of installation at the surface of the fuselage and projecting therefrom, in combination with an already-existing device positioned above a through-hole in the fuselage,
the device being modified to allow a power cable that powers the icing indicator to pass through the fuselage within its fastening.

5. The device according to claim 4, wherein the visually readable icing indicator is positioned on the windscreen wiper suspension arm in the continuation of an axis A of attachment of the said windscreen wiper through a hole that passes through the fuselage of an aircraft.

6. The device according to claim 4 wherein the icing indicator is of a passive type, comprising an elongate cylindrical component a few centimetres long, intended to project from the fuselage, the elongate cylindrical component comprising a surface-treated part situated at the end of the icing indicator furthest from the surface of the fuselage, the said treated part comprising means encouraging the early local formation of ice when flying under conditions that give rise to icing.
